(19) United States
(12) Patent Application Publication
(10) Pub. No.: US 2019/0080024 A1
(43) Pub. Date: Mar. 14, 2019

(54) SYSTEMS AND METHODS OF USING DIMENSION DATA, DEMOGRAPHIC DATA, PROJECT DATA AND PHOTOGRAMMETRY FOR RATING CUSTOMERS FOR DESIGN PROJECTS AND GENERATING DESIGN PLANS FOR PHYSICAL SPACES

(71) Applicant: VKD Virtual Kitchen Design Inc., Little Falls, NJ (US)

(72) Inventors: Kenneth L. Trabona, Sparta, NJ (US); John Onembo, Wharton, NJ (US)

(21) Appl. No.: 16/128,788

(22) Filed: Sep. 12, 2018

Related U.S. Application Data
(60) Provisional application No. 62/558,474, filed on Sep. 14, 2017.

(51) Int. Cl. G06F 17/30; G01C 11/02; G06F 17/50

(52) U.S. Cl. CPC G06F 17/30994; G01C 11/02; G06F 17/5009; G06F 17/30991; G06F 17/30265

(57) ABSTRACT

A computer-implemented method of rating customers for design projects includes providing a main computer system including a database of design products, capturing two or more digital images of a physical space, and transmitting the two or more digital images of the physical space to the main computer system. The method includes identifying any of the transmitted digital images that satisfy predetermined quality control criteria, and using photogrammetry software for processing the transmitted digital images that satisfy the predetermined quality control criteria to generate dimension data for the physical space. Geolocation information is extracted from the transmitted digital images and used to generate demographic data for a customer. The method includes obtaining from the customer a selection of at least one design product from the database of design products to generate project data linked to the customer, and using the dimension data for the physical space, the demographic data for the customer, and the project data linked to the customer to create a rating for the customer.

### CROSS REFERENCE TO RELATED APPLICATIONS

The present patent application claims benefit of U.S. Provisional Application No. 62/558,474, filed Sep. 14, 2017, and is related to U.S. Pat. Nos. 8,543,358 and 8,812,273, the disclosures of which are hereby incorporated by reference herein.

### FIELD OF THE INVENTION

The present patent application is directed to the field of computer-assisted design in general and specifically relates to systems and methods of using dimension data, demographic data, project data, and photogrammetry for rating customers for design projects, generating design plans for physical spaces and generating a directed design and order placement of materials therefor.

### BACKGROUND OF THE INVENTION

Designers, architects and planners are often used by clients to help create a design and plan specific for a particular application. In particular, a homeowner, customer or builder may use a designer to create a kitchen layout setting forth a plan for location and placement of kitchen cabinets and appliances. The client may then select from available cabinet, counter and appliance types, which are then ordered from a vendor for placement. The overall design plan and selection are determined using aesthetic, functional and budgetary constraints.

The designer must be able to visualize the space requiring design, using blueprints, photographic images or a site visit. The client must be able to view samples of cabinets, appliances and countertops, either using photographs, or by in person viewing of a vendor's products.

Interaction between the designer and the client yields a design plan meeting the client's requirements.

It is well recognized that computer assistance improves the efficiency of the overall design program, reduces inefficiency particularly in measuring and product selection, and improves client access to broad selections of materials information.

Graphical computer systems for generating design plans have been described in the art. (See U.S. Pat. Nos. 5,966,454; 6,005,969 and 6,459,435). In specific applications, methods for computer-based kitchen design are known in the art. (See U.S. Pat. Nos. 5,255,207; and 5,975,908). Kiosk computer terminals, which are generally self-contained, enclosed units having computer, video, and audio capabilities, often with a touch-screen are known in the art. (See U.S. Pat. Nos. 6,437,809; 6,415,291; 5,552,994; 5,949,411; 6,029,142; 6,536,663; 6,381,583; and 5,615,123. A kiosk terminal is often connected to a host computer system. (See U.S. Pat. No. 4,674,041). Thus, kiosks are often internet-mediated and network-mediated to effect electronic transactions using user-provided specifications.

Numerous websites on the Internet purporting to provide computer-based kitchen design, both relying on computer software alone and computer-assisted, but mediated by human designers. Another example is the website for Home Portfolio, Inc., which presents a selection of design products and directs the user to their nearest retailer.

The above advances in the field notwithstanding, the design process remains cumbersome, inefficient and difficult for many clients who are unable to achieve a directed design specific to their site and to obtain and order a wide selection of site specific materials meeting their design criteria.

The present invention solves these long-standing problems by coordinating a method for the directed design process, the designer, product selection and ordering with site-specific detail, images and measurements.

### SUMMARY OF THE INVENTION

Therefore it is an object of the present invention to provide a method for generating a directed design for a physical space requiring design comprising the steps of (a) maintaining a main computer, wherein the main computer is capable of exchanging data with a remote computer; (b) providing a means for acquiring digitally encoded signals representing an image of the physical space; (c) storing the digitally encoded signals in a imaging computer storage medium; (d) transmitting the stored digitally encoded signals to a design center; (e) designing an interior design plan using the transmitted digitally encoded signals; (f) storing the design plan in a design computer storage medium; (g) transmitting the stored design plan to the main computer; and (h) providing for remote computer communication link access to the stored design plan.

It is a further object of the present invention to provide a system for generating a directed design, the system comprising (a) a main computer, wherein the main computer is capable of exchanging data with a remote computer; (b) a means for accepting digitally encoded signals representing an image of a physical space requiring design; (c) a means for storing the digitally encoded signals in a imaging computer storage medium; (d) a means for transmitting the stored digitally encoded signals to a design center; (e) a designer for designing an interior design plan using the transmitted digitally encoded signals; (f) a means for storing the design plan in a design computer storage medium; (g) a means for transmitting the stored design plan to the main computer; and (h) a means for providing for remote computer communication link access to the stored design plan.

In one embodiment, a computer-implemented method of rating customers for design projects preferably includes providing a main computer system having a database of design products, transmitting two or more digital images of a physical space to the main computer system, using the main computer system for identifying any of the transmitted digital images that satisfy predetermined quality control criteria, and using photogrammetry software for processing the transmitted digital images that satisfy the predetermined quality control criteria to generate dimension data for the physical space.

In one embodiment, a method of rating customers for design projects preferably includes using the dimension data for the physical space to generate a three-dimensional data set rendering of the physical space.

In one embodiment, an electronic device is used for capturing the two or more digital images of the physical space. In one embodiment, the internet is used for electronically transmitting the two or more captured digital images to the main computer system. In one embodiment, the electronic device may include a single camera. In one embodiment, the electronic device may include a two camera device with a first camera and a second camera that is offset from the first camera. In one embodiment, the first and second cameras are configured to simultaneously capture two different digital images of the physical space, preferably from different angles.

In one embodiment, a method of rating customers for design projects may include placing at least one object within the physical space, directing the camera toward the physical space, using the camera to capture a first digital image of the physical space, whereby the at least one object is visible within the first digital image, changing the angle at which the camera is directed toward the physical space, and using the camera to capture a second digital image of the physical space, whereby the at least one object is visible within the second digital image, and whereby the at least one object is visible within the captured first and second digital images.

In one embodiment, the quality control criteria used for determining whether a digital image is acceptable or unacceptable for generating dimension data may include the blurriness level of a digital image, the focus level of a digital image, the brightness level of a digital image, the darkness level of a digital image, the orientation of a digital image, the orientation of a camera that captured a digital image, a camera set-up, a camera zoom, a camera aperture opening, the F-stop of a camera, a digital fingerprint of a camera, and/or the aspect ratio of a camera.

In one embodiment, a method of rating customers for design projects may include rejecting any of the transmitted digital images that do not satisfy one or more of the quality control criteria, and generating a message to the customer that one or more of the transmitted digital images has been rejected for not satisfying one or more of the quality control criteria.

In one embodiment, a method of rating customers for design projects may include using Global Positioning System (GPS) technology for determining a geolocation that is associated with the transmitted digital images, and using the geolocation that is associated with the transmitted digital images for generating demographic data about a customer.

In one embodiment, a method of rating customers for design projects desirably includes using the dimension data for the physical space and the demographic data about the customer to assign a rating to the customer.

In one embodiment, a method of rating customers for design projects may include using the rating assigned to the customer to determine if the customer is a qualified lead. In one embodiment, if the customer is a qualified lead, a method may include sending two or more targets to the customer for use in capturing supplemental digital images of the physical space.

In one embodiment, a method of rating customers for design projects may include obtaining a selection from the customer regarding one or more design products in the database of design products to generate project data linked to the customer, and using the project data linked to the customer for generating the rating assigned to the customer.

In one embodiment, a method of rating customers for design projects may include using an internet protocol (IP) address associated with the customer for generating additional demographic data about the customer.

In one embodiment, the main computer is preferably configured to send and receive communications from electronic devices for transmitting the two or more digital images. The electronic devices may include smart devices, smart phones, tablets, electronic cameras, desktop computers, laptop computers, and/or internet-based devices capable of communicating via phone lines, the internet, wirelessly, and/or via a Cloud-based environment.

In one embodiment, a method for rating customers for design projects may include using the dimension data, the demographic data, and the project data linked to the customer to create a rating for the customer. In one embodiment, the rating for the customer may be compared to ratings assigned to other customers to create a tiered rating hierarchy.

In one embodiment, a computer-implemented method of rating customers for design projects preferably includes providing a main computer system including a database of design products, capturing two or more digital images of a physical space, and transmitting the two or more digital images of the physical space to the main computer system.

In one embodiment, a method of rating customers for design projects may include identifying any of the transmitted digital images that satisfy predetermined quality control criteria, and using photogrammetry software for processing the transmitted digital images that satisfy the predetermined quality control criteria to generate dimension data for the physical space.

In one embodiment, geolocation information may be extracted from the transmitted digital images, and the extracted geolocation information is preferably used to generate demographic data for a customer.

In one embodiment, a method of rating customers for design projects desirably includes obtaining from the customer a selection of at least one design product from the database of design products to generate project data linked to the customer, and using the dimension data for the physical space, the demographic data for the customer, and the project data linked to the customer to create a rating for the customer.

In one embodiment, a method of rating customers for design projects desirably includes using the rating assigned to the customer to determine whether the customer is a qualified lead, and, if the customer is determined to be a qualified lead, sending targets to the customer for use in capturing supplemental digital images of the physical space.

In one embodiment, a method of rating customers for design projects preferably includes placing the targets that have been sent in the physical space, and capturing two or more supplemental digital images of the physical space, whereby the two or more targets are visible within the two or more supplemental digital images.

In one embodiment, a method of rating customers for design projects desirably includes transmitting the two or more supplemental digital images to the main computer, using the photogrammetry software for processing the transmitted two or more supplemental digital images to generate supplemental dimension data for the physical space, and comparing the first dimension data for the physical space with the supplemental dimension data for the physical space.

In one embodiment, a computer-implemented system for rating customers for design projects desirably includes a main computer system having photogrammetry software and a database of design products.

In one embodiment, a computer-implemented system for rating customers for design projects preferably includes code for capturing two or more digital images of a physical space.

In one embodiment, a computer-implemented system for rating customers for design projects preferably includes code for transmitting the two or more captured digital images of the physical space to the main computer system.

In one embodiment, a computer-implemented system for rating customers for design projects preferably includes code for identifying any of the transmitted digital images that satisfy predetermined quality control criteria.

In one embodiment, a computer-implemented system for rating customers for design projects preferably includes code for using photogrammetry software for processing the transmitted digital images that satisfy the predetermined quality control criteria to generate dimension data for the physical space.

In one embodiment, a computer-implemented system for rating customers for design projects preferably includes code for extracting geolocation information from the transmitted digital images of the physical space.

In one embodiment, a computer-implemented system for rating customers for design projects preferably includes code for using the geolocation information extracted from the transmitted digital images to generate demographic data for a customer.

In one embodiment, a computer-implemented system for rating customers for design projects preferably includes code for obtaining from the customer a selection of at least one design product from the database of design products to generate project data linked to the customer.

In one embodiment, a computer-implemented system for rating customers for design projects preferably includes code for using the dimension data for the physical space, the demographic data for the customer, and the project data linked to the customer to create a rating for the customer.

In one embodiment, a computer-implemented system for rating customers for design projects preferably includes code for using the rating assigned to the customer to determine whether the customer is a qualified lead.

In one embodiment, a computer-implemented system for rating customers for design projects preferably includes code for sending targets to customers who have been determined to be qualified leads.

In one embodiment, a computer-implemented system for rating customers for design projects preferably includes code for capturing two or more supplemental digital images of the physical space, whereby the targets are visible within the two or more supplemental digital images.

In one embodiment, a computer-implemented system for rating customers for design projects preferably includes code for transmitting the two or more supplemental digital images to the main computer.

In one embodiment, a computer-implemented system for rating customers for design projects preferably includes code for using the photogrammetry software for processing the transmitted two or more supplemental digital images to generate supplemental dimension data for the physical space.

In one embodiment, the system for rating customers for design projects preferably includes code for comparing the first dimension data for the physical space with the supplemental dimension data for the physical space.

These and other preferred embodiments of the present invention will be described in more detail below.

### BRIEF DESCRIPTION OF THE DRAWINGS

FIG. 1: Flow chart describing an exemplary interaction of a client at a kiosk for kitchen design located at a physical vendor location.

FIG. 2: Flow chart describing an exemplary interaction of a client at a kiosk for kitchen design located at a physical vendor location.

FIG. 3: Flow chart describing an exemplary interaction of a client at a kiosk for kitchen design located at a physical vendor location.

FIG. 4: Representation of a preferred embodiment of the invention describing touch screen options and administrative options at a kiosk.

FIG. 5: Representation of a preferred embodiment of the invention describing direct design at a kiosk.

FIG. 6: Representation of a preferred embodiment of the invention describing member login at a kiosk.

FIG. 7: Representation of a preferred embodiment of the invention describing kitchen design at a kiosk.

FIG. 8: Representation of a preferred embodiment of the invention describing personal management system for a kitchen design project accessible on the world wide web or at a kiosk.

FIG. 9: Representation of a preferred embodiment of the invention describing design product selection and price quotation accessible on the world wide web or at a kiosk.

FIG. 10: Representation of a preferred embodiment of the invention describing quick quote option at a kiosk.

FIG. 11: Representation of a preferred embodiment of the invention describing live help options at a kiosk.

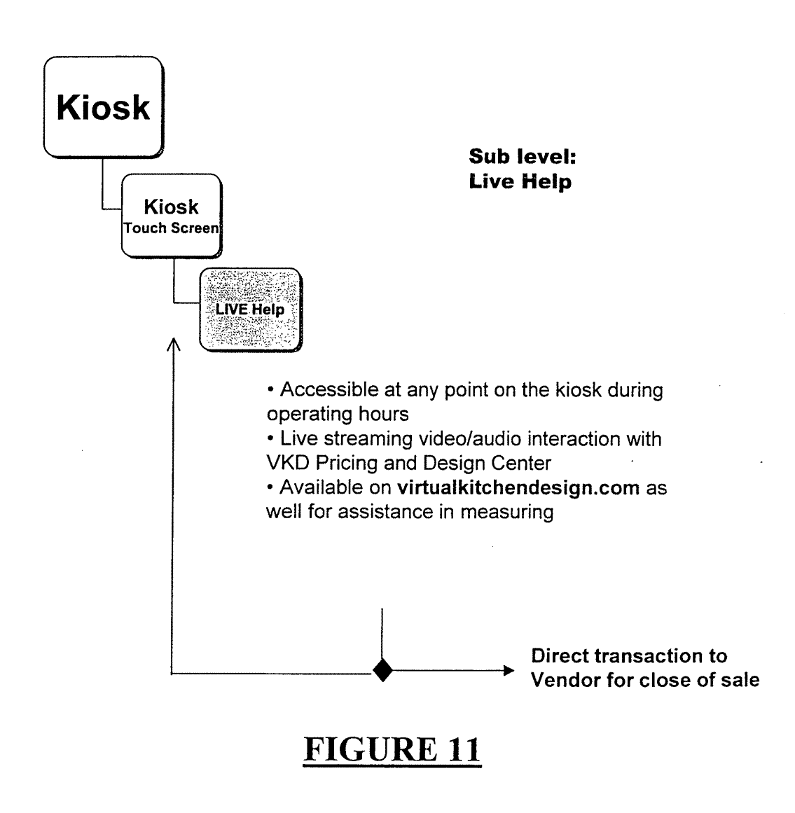

FIG. 12: Representation of a preferred embodiment of the invention describing live help options at a kiosk.

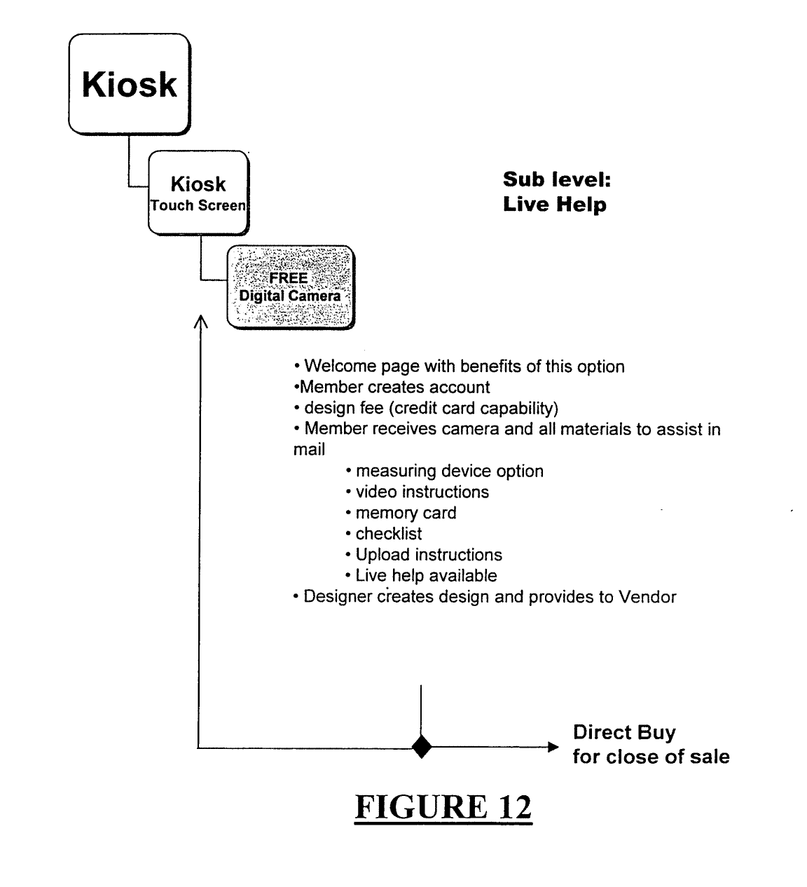

FIG. 13 shows a portion of a smart phone having two cameras, in accordance with one embodiment of the present patent application.

FIG. 14A shows a first stage of a method for generating design plans for physical spaces, in accordance with one embodiment of the present patent application.

FIG. 14B shows a second stage of a method for generating design plans for physical spaces, in accordance with one embodiment of the present patent application.

FIG. 15 shows a physical space with targets secured to surfaces located within the physical space, in accordance with one embodiment of the present patent application.

### DETAILED DESCRIPTION

The present invention provides a method for generating a directed design for a physical space requiring design comprising the steps of (a) maintaining a main computer, wherein the main computer is capable of exchanging data with a remote computer; (b) providing a means for acquiring digitally encoded signals representing an image of the physical space; (c) storing the digitally encoded signals in a imaging computer storage medium; (d) transmitting the stored digitally encoded signals to a design center; (e) designing an interior design plan using the transmitted digitally encoded signals; (f) storing the design plan in a design computer storage medium; (g) transmitting the stored design plan to the main computer; and (h) providing for remote computer communication link access to the stored design plan. It is contemplated that stored images may accurately represent true image measurements and dimensions. It is further contemplated that design plan may represent actual measurements and images.

According to still anther embodiment of the invention, wherein the remote computer is capable of transmitting a data request to the main computer. According to still yet another embodiment of the present invention, the method further comprises the step of transmitting an order request for the design product from the remote computer to the main computer. According to a further embodiment of the invention, a plurality of vendor computers exchange product data information with the main computer. Still according to another embodiment of the invention, the method is further comprising the step of displaying the design plan on the remote computer. According to another embodiment of the invention, the method is further comprising the step of displaying a plurality of design products on the kiosk, corresponding to user search criteria. It is specifically contemplated that design products may be stored in a plurality of databases, which may be independently maintained by a plurality of vendors. According to this embodiment, a user may select from a variety of displayed vendor products and styles such as in the case of kitchen design: cabinetry, countertops, fixtures, appliances and hardware. According to this embodiment, the user selection may be effected through the use of a touch screen type kiosk. According to a variant embodiment, the user selection may be effected via a keyboard, keypad or pointing device. According to another variant embodiment, the selection may be effected at the user's personal home computer via an online communications link such as the Internet. According to another embodiment of the invention, the remote computer is an electronic computer kiosk, wherein the kiosk is electronically linked to a main computer. According to yet another embodiment of the invention, the method is further comprising the step of transmitting the stored digitally encoded signals to the main computer. According to still another embodiment, the design center comprises a human designer. According to yet still another embodiment of the invention, the design center comprises a design computer. It is specifically contemplated that the design computer may be a computing device dedicated specifically to design function and directed design plan generation. According to an alternative embodiment of this invention, the design computer is the main computer. The design computer is capable of executing software programs facilitating generation of the design plan. According to a further embodiment of the invention, the electronic computer kiosk is located at a physical location, the location being a vendor of design products. According to a particular embodiment of the invention, the directed design is a kitchen design plan. It is specifically contemplated that this invention may be embodied in generating a design for a variety of plans including but not limited to any field requiring design such as landscaping, building, interiors, exteriors, clothing and product placement. According to a preferred embodiment of the invention, the design product is a kitchen design product. According to yet a further embodiment of the invention, the main computer stores data related to a plurality of design products. According to a preferred embodiment of this invention, the method further comprises the step of displaying data related to the design product on the remote computer. According to still yet another embodiment of this invention, the means for accepting digitally encoded signals is a digital camera. Alternative imaging devices such as digitizers and scanner are specifically contemplated by the invention. According to one embodiment of this invention, conventional photographs taken of the space requiring design are scanned into digital format for transmission to the design center. According to another embodiment, a user captures images using a portable cell phone based imaging device. According to still another embodiment of this invention, the digitally encoded signals encode a two-dimensional image of the space requiring design, reflected as the site-plan dimensions. According to one embodiment of this invention, the actual dimensions of the image represented by the digitally encoded signals are calculated as a scale factor, wherein the scale factor has units of length per pixel and is obtained by (a) establishing a known distance in the image, the known distance having a first point and an end point, and dividing the known distance by the number of pixels represented on the straight line between the first point and the end point of the known distance; (b) measuring a pixel distance on the image, the pixel distance having a first pixel and a last pixel, wherein the pixel distance is the number of pixels represented on the straight line between the first pixel and the last pixel; and (c) multiplying the pixel distance by the scale factor. The present invention specifically contemplates alternative methods of photogrammetry and pixel analysis in order to transform various two-dimensional images of the space into specific dimensions. The present invention contemplates that displays may include videographic audio representations in a real-time fashion, including streaming video and audio. The present invention further provides the method further comprising the step of displaying the design plan on a virtual reality device. In a particular embodiment, the virtual reality device is a device worn by a user. In a most preferred embodiment of this invention, the virtual reality device is a headset. It is also specifically contemplated that smells may be introduced into the virtual reality device, thus providing a user with a more complete sense of environment. According to one such embodiment, a user wearing a virtual reality headset can experience a virtual kitchen complete with the aromas of cooked food.

The present invention also provides system for generating a directed design, the system comprising (a) a main computer, wherein the main computer is capable of exchanging data with a remote computer; (b) a means for accepting digitally encoded signals representing an image of a physical space requiring design; (c) a means for storing the digitally encoded signals in a imaging computer storage medium; (d) a means for transmitting the stored digitally encoded signals to a design center; (e) a designer for designing an interior design plan using the transmitted digitally encoded signals; (f) a means for storing the design plan in a design computer storage medium; (g) a means for transmitting the stored design plan to the main computer; and (h) a means for providing for remote computer communication link access to the stored design plan. The present invention also provides a computer program product to effectuate the provided method.

The present invention may be practiced on a single computer, preferably using a client-server architecture. However, because the present invention preferably involves storage and/or searching of large numbers of graphical images of design products, the present invention preferably is implemented on a client-server system, wherein at least one client computer and at least one server computer is connected over a network, such as the Internet.

The Internet is a worldwide-decentralized network of computers having the ability to communicate with each other. The Internet has gained broad recognition as a viable medium for communicating and for conducting business. The World-Wide Web (Web) is comprised of server-hosting computers (Web servers) connected to the Internet that have hypertext documents (referred to as Web pages) stored there within. Web pages are accessible by client programs (e.g., Web browsers) utilizing the Hypertext Transfer Protocol (HTTP) via a Transmission Control Protocol/Internet Protocol (TCP/IP) connection between a client-hosting device and a server-hosting device. While HTTP and Web pages are the prevalent forms for the Web, the Web itself refers to a wide range of protocols including Secure Hypertext Transfer Protocol (HTTPS), File Transfer Protocol (FTP), and Gopher, and Web content formats including plain text, HyperText Markup Language (HTML), Extensible Markup Language (XML), as well as image formats such as Graphics Interchange Format (GIF) and Joint Photographic Experts Group (JPEG).

A Website is conventionally a related collection of Web files that includes a beginning file called a “home” page. From the home page, a visitor can access other files and applications at a Web site. A large Web site may utilize a number of servers, which may or may not be different and which may or may not be geographically dispersed. For example, the Web site of the International Business Machines Corporation (www.ibm.com) includes thousands of Web pages and files spread out over multiple Web servers in locations worldwide.

A Web server (also referred to as an HTTP server) is a computer program that generally utilizes HTTP to serve files that form Web pages to requesting Web clients. Exemplary Web servers include International Business Machines Corporation's family of Lotus Domino® servers, the Apache server (available from www.apache.org), and Microsoft's Internet Information Server (IIS), available from Microsoft Corporation, Redmond, Wash. A Web client is a requesting program that also generally utilizes HTTP. A browser is an exemplary Web client for use in requesting Web pages and files from Web servers. A Web server waits for a Web client, such as a browser, to open a connection and to request a specific Web page or application. The Web server then sends a copy of the requested item to the Web client, closes the connection with the Web client, and waits for the next connection.

HTTP allows a browser to request a specific item, which a Web server then returns and the browser renders. To ensure that browsers and Web servers can interoperate unambiguously, HTTP defines the exact format of requests (HTTP requests) sent from a browser to a Web server as well as the format of responses (HTTP responses) that a Web server returns to a browser. Exemplary browsers that can be utilized with the present invention include, but are not limited to, Netscape Navigator® (America Online, Inc., Dulles, Va.) and Internet Explorer® (Microsoft Corporation, Redmond, Wash.). Browsers typically provide a graphical user interface for retrieving and viewing Web pages, applications, and other resources served by Web servers.

As is known to those skilled in this art, a Web page is conventionally formatted via a standard page description language such as HTML, which typically contains text and can reference graphics, sound, animation, and video data. HTML provides for basic document formatting and allows a Web content provider to specify anchors or hypertext links (typically manifested as highlighted text) to other servers. When a user selects a particular hypertext link, a browser running on the user's client device reads and interprets an address, called a Uniform Resource Locator (URL) associated with the link, connects the browser with a Web server at that address, and makes a request (e.g., an HTTP request) for the file identified in the link. The Web server then sends the requested file to the client device, which the browser interprets and renders within a display screen.

One of skill in the art will appreciate that the present invention may be embodied as methods, data processing systems, and/or computer program products. Accordingly, the present invention may predominantly take the form of a hardware embodiment, a predominantly software embodiment running on general-purpose hardware or an embodiment predominantly combining software and hardware aspects. Furthermore, the present invention may take the form of a computer program product on a computer-usable storage medium having computer-usable program code embodied in the medium. Any suitable computer readable medium may be utilized including hard disks, CD-ROMs, optical storage devices, or magnetic storage devices.

Computer program code for carrying out operations of the present invention may be written in an object oriented programming language such as JAVA®, Smalltalk or C++. The computer program code for carrying out operations of the present invention may also be written in conventional procedural programming languages, such as “C”, JavaScript, Visual Basic, TSQL, Perl, or in a functional (or fourth generation) programming language such as Lisp, SML, or Forth. In addition, Microsoft Active Server Pages (ASP) technology and Java Server Pages (JSP) technology may be utilized. PHP is a widely used general-purpose scripting language that is especially suited for Web development and can be embedded into HTML. The program code may execute entirely on one or more Web servers and/or application servers, or it may execute partly on one or more Web servers and/or application servers and partly on a remote computer (i.e., a user's Web client), or as a proxy server at an intermediate point in the network. In the latter scenario, the remote computer may be connected to the Web server through a LAN or a WAN (e.g., an intranet), or the connection may be made through the Internet (e.g., via an Internet Service Provider).

The present invention is described below with reference to block diagram and flowchart illustrations of methods, apparatus (systems) and computer program products according to an embodiment of the invention. It will be understood that each block of the block diagrams and/or flowchart illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create structures for implementing the functions specified in the block diagram and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function specified in the block diagram and/or flowchart block or blocks.

The computer program instructions may also be loaded onto a computer or other programmable data processing apparatus to cause a series of operational steps to be performed on the computer or other programmable apparatus to produce a computer implemented process or method such that the instructions which execute on the computer or other programmable apparatus provide steps for implementing the functions specified in the block diagram and/or flowchart block or blocks.

One of skill in the art will appreciate that a database is a collection of data that is organized in tables or other conventional forms of organization. A database typically includes a database manager and/or database server that facilitates accessing, managing, and updating data within the various tables of a database. Exemplary types of databases that can be used to implement the product database of the present invention include relational databases, distributed databases (databases that are dispersed or replicated among different points in a network), and object-oriented databases. Relational, distributed, and object-oriented databases are well understood by those of skill in the art and need not be discussed further herein. Since the present invention preferably includes large quantities of design products such as kitchen design products in the preferred embodiment of the present invention, a database system that is particularly adapted for storing and searching large numbers of products, such as Oracle 8i Visual Image Retrieval (VIR) available from Oracle Corp., Redwood Shores, Calif. may be used. See the Oracle 8i Visual Information Retrieval Data Sheet, March 1999. However, other databases may be used, including IBM's DB2® database, Microsoft's SQL server database, and database products from Sybase and Computer Associates.

The database server is an application server that operates as a “middleman” server between the Web server and the plurality of databases. The database server generally includes program code and logic for retrieving data from the databases (and from sources external to the Web site) in response to requests from the Web server. The database server preferably is adapted for searching and storing of large numbers of kitchen design products, such as Oracle VIR. Other commercial database servers that may be utilized as a database server in the illustrated system include Microsoft's SQL server, IBM DB2® Universal Database server, and the WebSphere® Net.Commerce server, the latter two being available from International Business Machines Corporation, Armonk, N.Y.

Virtual reality is the simulation of an environment that can be represented in a three-dimensional display representing width, height, and depth. A virtual reality device can provide a user a user with the ability to interact with the virtual simulated environment. Such interaction may include full real-time motion with sound and possibly with tactile and other forms of feedback. The simplest form of virtual reality is a three dimensional image that can be explored interactively at a personal computer, usually by manipulating keys or the mouse so that the content of the image moves in some direction or zooms in or out. More sophisticated efforts involve such approaches as wrap-around display screens, actual rooms augmented with wearable computers, and joystick devices that provide a user with the “feel” of display images. A virtual reality device can simulate a real environment such as the interior of a building or a design space, such as a kitchen. Moreover, the device can display the environment in a variety of formats and from a variety of angles. Changing certain parameter such as the cabinet style in a kitchen will result in the changed display, giving the user the ability to “virtually” preview and tryout various combinations or environmental changes before actually performing physical changes in a real space. Virtual reality devices have been widely described including in U.S. Pat. No. 5,991,085 and references therein.

One of skill in this art will appreciate that a kiosk is generally a terminal for performing tasks, which may be computerized, and which exists in a specific physical space. In the present invention, a kiosk is defined as a device capable of digitally transmitting digitally encoded signals to a main computer.

Digitally transmitting is the act of sending images, information, or other materials electronically from a device capable of sending digitally encoded signals to a device capable of receiving the signals, in a digital format. Digital formats are known to those skilled in the art and will not be further discussed. Similarly, a digitally encoded signal is an electronic signal in digital format.

A main computer is a device capable of sending and receiving digitally encoded signals from kiosks. A main computer for purposes of the present invention has other capabilities, which may include accessing a database of kitchen design products, routing digitally-encoded signals to other devices, or serving as general electronic storage media. General electronic storage media is well known to those skilled in this art.

Again, the present invention may be practiced using a single main computer, or using a series of electronically linked computers, each having separate and distinct information.

Directed design is the practice and field of arranging and positioning fixtures in an efficient and aesthetically pleasing orientation. Kitchen design is the practice and field of arranging kitchen areas in an efficient and aesthetically pleasing manner.

Design products are the elements and fixtures particular to a particular design application. For example, in the preferred embodiment, kitchen design products are known to those skilled in the art and are all those elements which found in a kitchen area, including but not limited to refrigerators, stoves, sinks, automatic dishwashers and other functional appliances; cabinets, counter-tops, cabinet doors, and other structural elements; tables, chairs, lighting fixtures, flooring material, and other decorative elements and furnishings.

One of skill in the art will appreciate that photogrammetry generally refers to relativity of dimensions and measurements. In the present invention, photogrammetry is the practice of determining the physical dimensions of objects that appear in a digital image.

In order to use photographs in a computer environment, they must be converted into digital format. There are several ways to convert photographs into digital format; they can be obtained directly from a digital camera or scanned into the computer using a scanning device. Once in digital format, photos can be enhanced for printing, or imported into specific software for dimension extraction (Photogrammetry). Specific areas in the photo can then be highlighted. Thus, photogrammetry for purposes of this invention is the process of extracting dimensions from two-dimensional photographs. The object(s) from which dimensions need to be extracted must appear in more than one photograph and viewed from different angles, most preferably from ninety-degree intervals. Also known as photogrammetry in the art, photogrammetry techniques thus allow conversion of images of an object into a 3D model. Using a digital camera with known characteristic (lens focal length, imager size and number of pixels).

A digital image is an image in digital format, defined by a rectangular matrix of pixels. A pixel is a single point on imaging media, which may include computer monitors, television screens, or other devices capable of displaying an image in digital format.

Conventionally, in photogrammetry, images of an existing structure or location are captured; the images are then scanned into a computer. From the scanned images the computer can dimension the building to within an accuracy of a few millimeters.

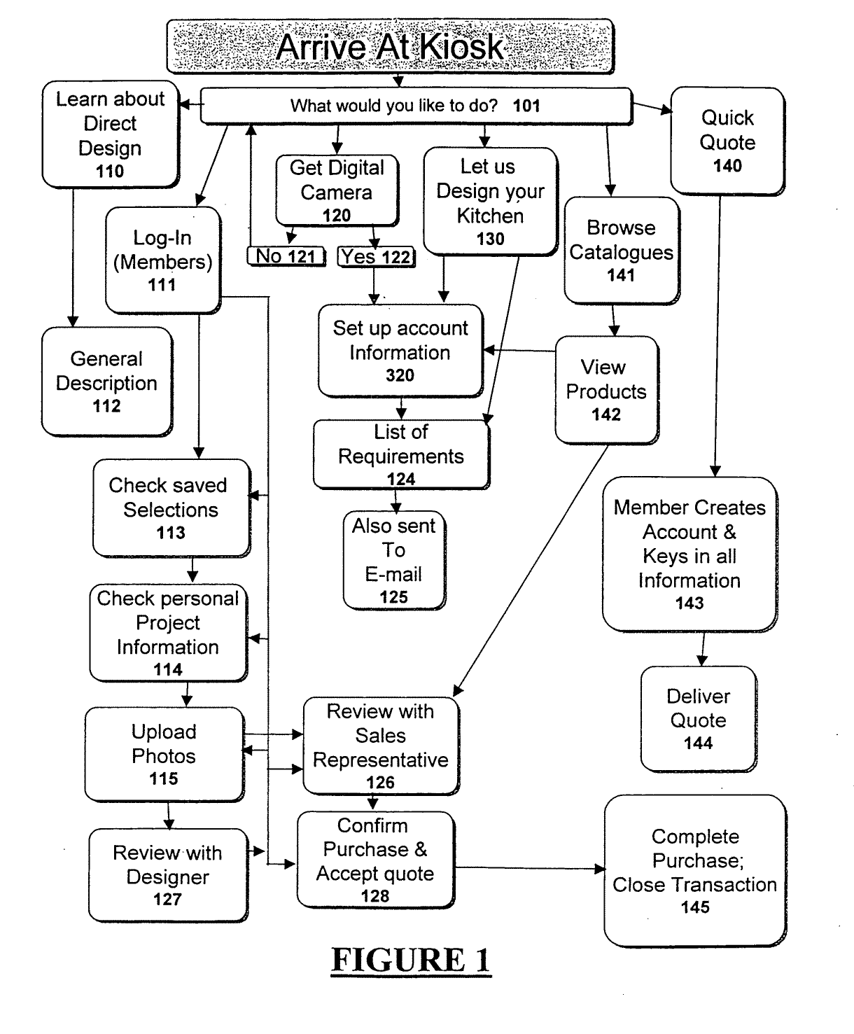

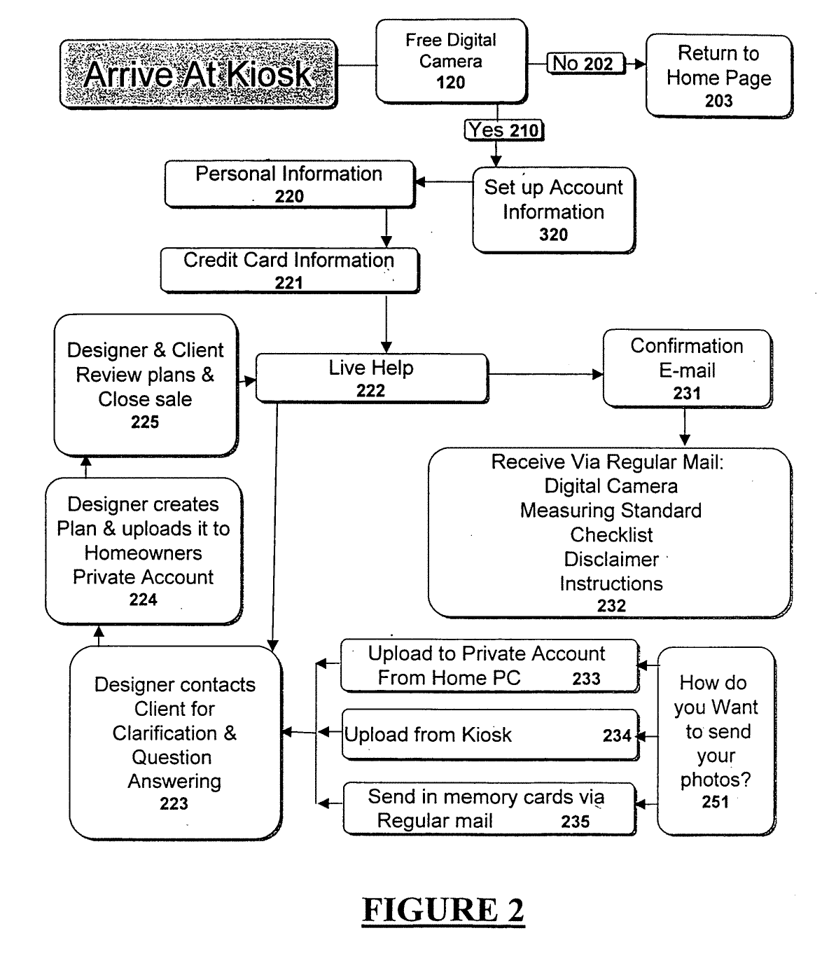

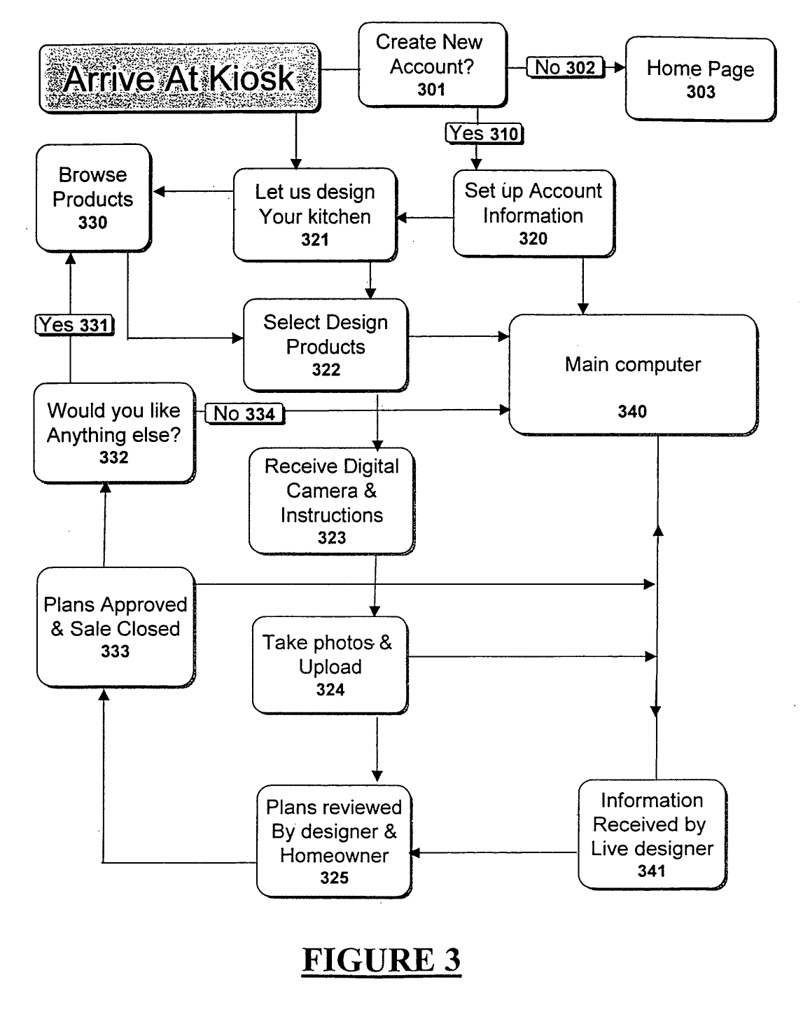

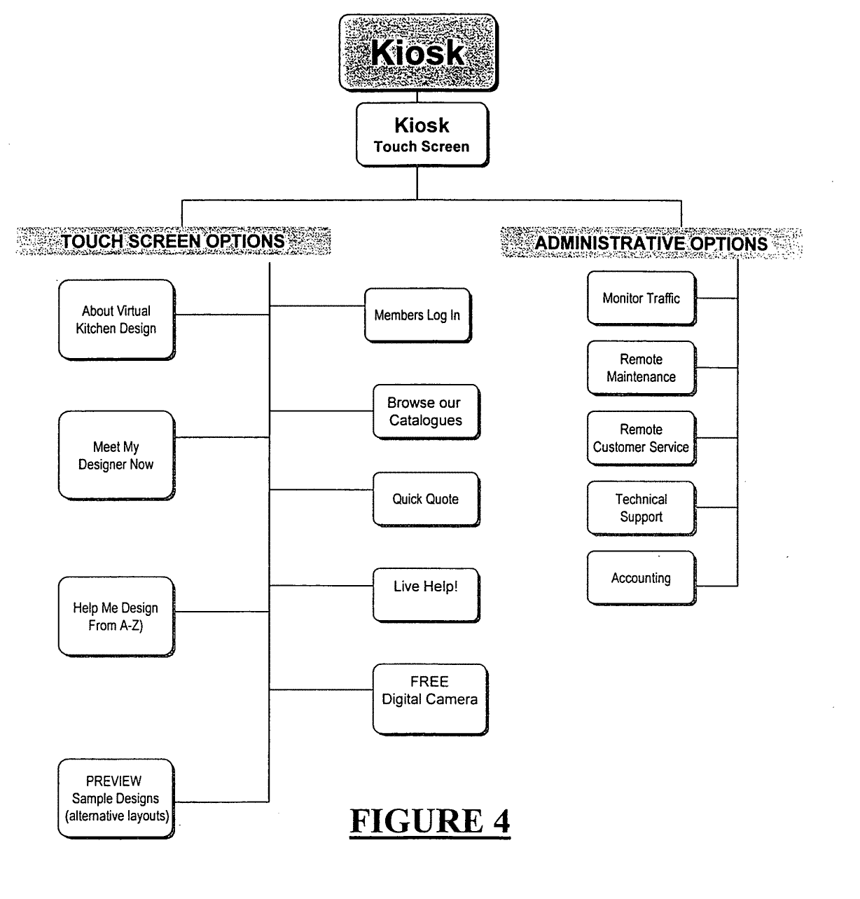

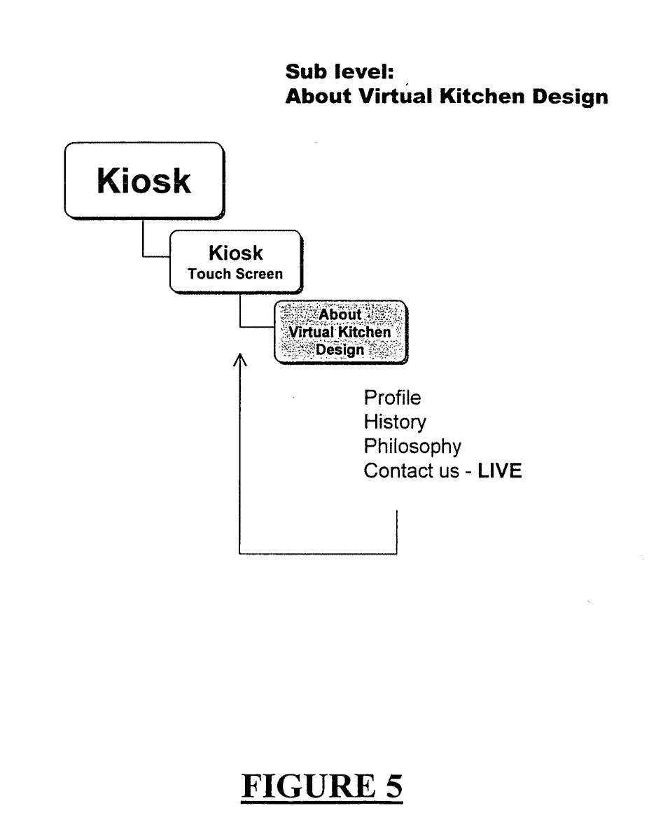

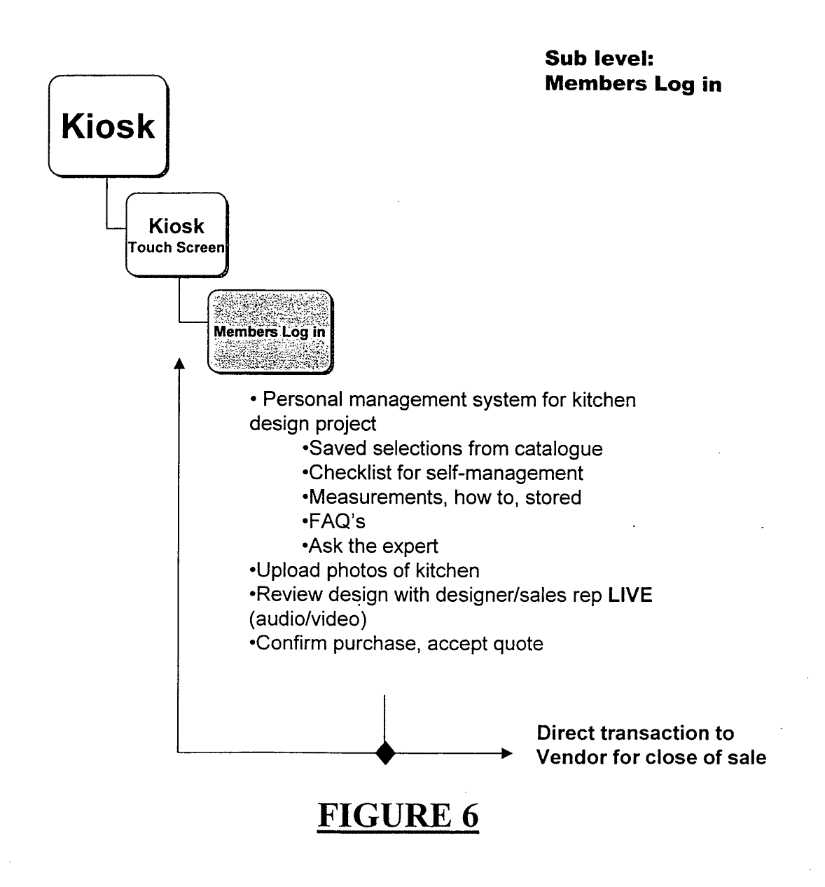

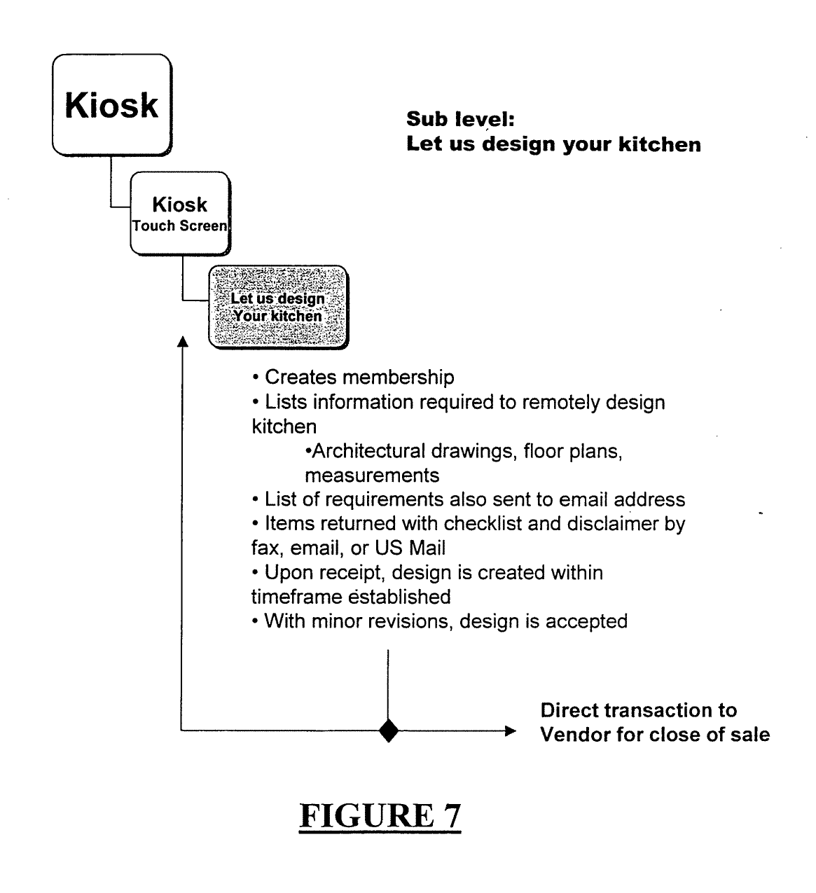

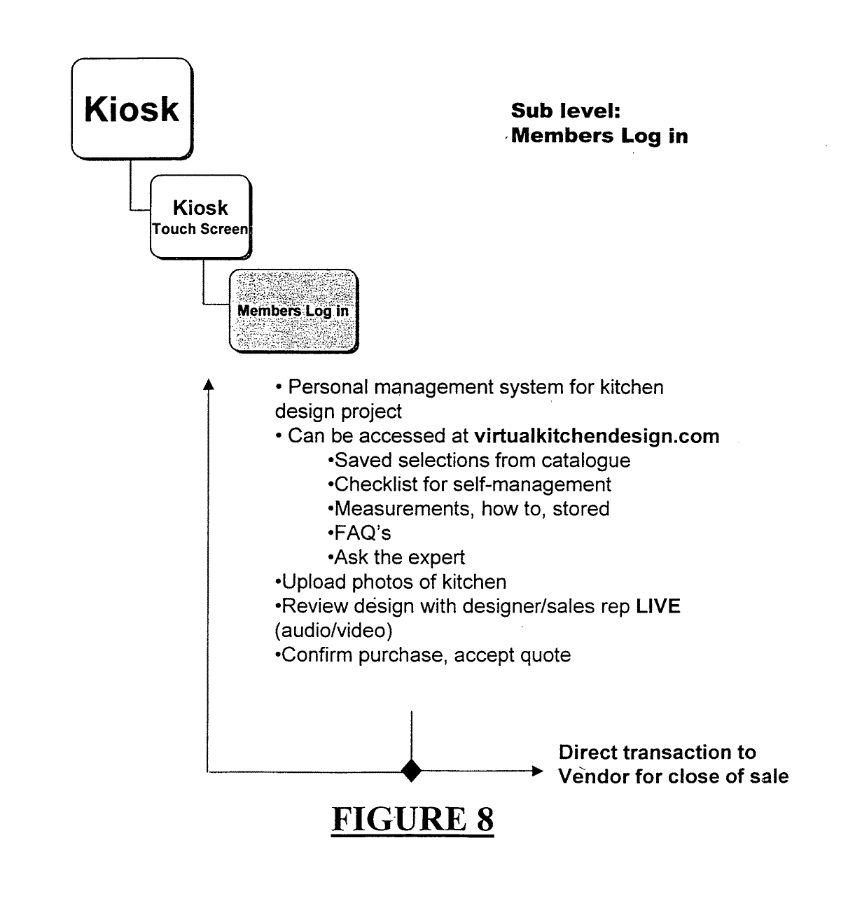

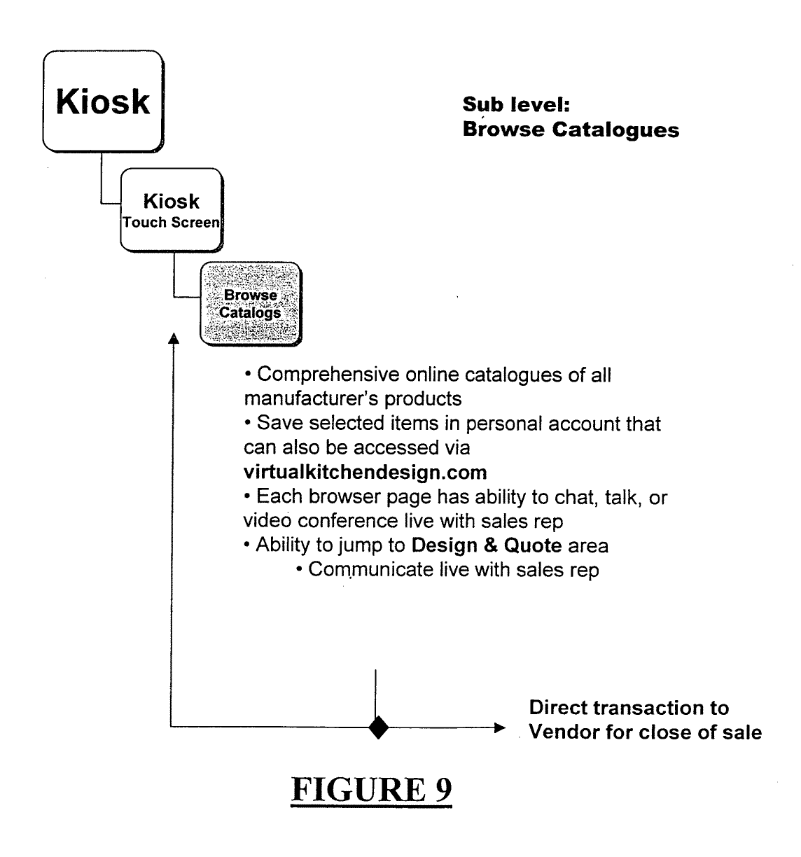

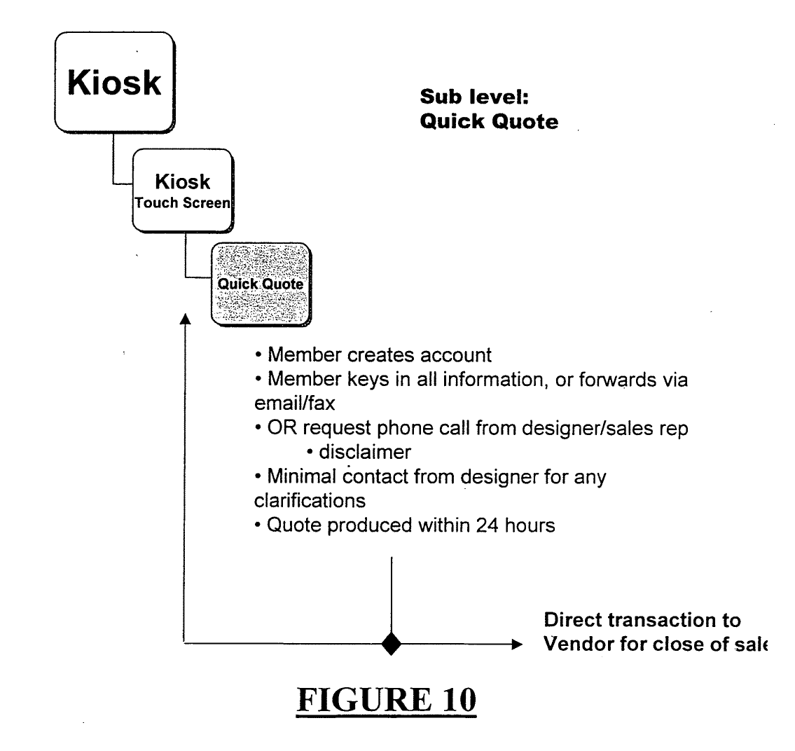

The dimensions of objects in the digital image can be determined directly by examining and converting corresponding pixel dimensions of the image by means of an appropriate scale factor. A pixel dimension is the distance between two pixels, measured as the number of pixels represented by the straight line between to pixels, and is therefore related to the real dimension of the image according to the following relationship: Real Dimension=(Pixel Dimension) (Scale Factor). The Scale Factor is defined by a set of intrinsic parameters, which may be unique to each image, and has units of length/pixel. Turning to FIG. 1 shows a flow chart indicating an exemplary interaction of a client at a kiosk 1 for kitchen design. It is understood that the screens and options may be designed in a variety of ways providing a variety of options. The kiosk 1 presents the client/user with a screen of options including information about directed design at 110, receiving a digital camera at 120, kitchen design 130, browsing catalogues for kitchen design products at 141 and for a quick price quote on selected items at 140. In addition the client/user has the option to login to an already existing account at 111. If the client/user is already a member, having previously established an account, he can access stored data 113 or check on other project information such as design products selected for the project, which are associated with the account 114 or store additional data or information such as digital images 115. The data may be reviewed with a sales representative 126 or with a designer 127. If product has been selected the client/user may confirm the purchase 128. If the client/user opts to receive a digital camera 120 they create an account, thereby gaining membership 320. Entry of design requirements is stored at 124 and may be sent to a remote computer via electronic mail 125. If the client elected to browse for design products at 141 they may also elect to display visual images of the products at the terminal 142 and select design products and confirm for ordering at 128. Purchase is complete and the transaction closed 145. If a client user has elected to receive a quotation for selected design product 140, the information is stored in the member account 143 and the quote is delivered 144 either to the kiosk or via mail, e-mail, telephone or other client/user selected means. FIG. 2 details the interaction of the client/user who elects to receive a digital camera 120 in the example described in FIG. 1. Account information is collected and stored 320 thereby creating membership. This information includes personal information 220 and credit card information 221 and may include a membership fee. Live help is available at 222 at which time the client/user may elect to receive account information via electronic mail or other delivery means such as telephonic or hard copy via mail 231. The selected digital camera is issued for the account and delivered to the client/user at the kiosk or by other conventional delivery means such as through the mail 232. The client/user captures digital images of the space requiring design and transmits the images to the designer 251 either using his home personal computer 233 or at a kiosk 234 or by conventional mail delivery of the camera or the memory card there from 235. The Designer confirms and clarifies the images received by contacting the client/user 233 and proceeds to create the design and transmit the design to the main computer in a format accessible through client's account but not accessible by other client accounts 224. The client/user and the Designer review together the prepared design and any selected design products 225. Turning now to FIG. 3, the client/user information is transmitted to the main computer 340 including account information 320, kitchen design information 321 and selected design products 322, digital images taken by the client/user 324 and information received by the Designer 341. In addition the approved design plan and any transactional information 333 are stored at the main computer 340. FIGS. 4-10 show a preferred embodiment describing touch screen options at a kiosk. An initial “Splash” screen also known as a Welcome Page is typically graphically appealing and simple and may involve a revolving movie, no sound, hitting the high points and advantages of directed design, in a preferred embodiment, directed kitchen design also known as virtual kitchen design or VKD. The splash screen invites a client/user to “Touch Screen to begin”. Initial options are “ABOUT US” or in the preferred embodiment, “About Virtual Kitchen Design” which provides a company profile, in this preferred embodiment, about VKD. Additional options describe cabinet and countertop lines, short descriptions of each vendor company and lead to screens such as “browse our catalogues”. “Live Help” provides answers to questions from a human, advising a client/user to pick up a phone, which may be attached to the kiosk or which may be a virtual telephonic connection mediated via an Internet connection. Other screens provide information including a library of frequently asked questions also known as FAQ. An option is provided to “MEET MY DESIGNER NOW” initiating an interface with a directed design designer which may be effected electronically and with video and/or telephonic connection. A “Quick Quote” screen facilitates price comparisons with other design product vendors. “Preview Design” or in this preferred embodiment, “Preview Kitchen Design” provides the client/user with a visual image of a paradigmatic design kitchen with average features for each level of cabinet line. Price ranges may be selected by the client/user.

### Example

A use of the present invention is illustrated by the following example.

### Example

Kitchen Design

Client arrives at vendor location and activates direct design kiosk, marked as “Kitchen Cabinetry Direct Design with video and audio assist to a live vendor sales representative. Using the kiosk touch screen, the client has options to choose from such as (a) “Get your digital camera now” thereby creating an client user account; (b) “Browse cabinetry catalogue”; (c) “Talk to a Representative” with or without live video; (d) “Call Me Back”; (e) “Order Now”.

Client selects the digital camera option, which is provided by the vendor to meet certain specifications facilitating photogrammetric extraction of dimensional data from two-dimensional images. Client creates a client user account including secure payment information such as credit card information and secure personal and contact information, thereby facilitating computer-mediated maintenance of client user specifications. The information is entered at the kiosk using the integrated video touch screen, which is well known in the art. The kiosk transmits the client information to a main computer, which stores on a computer media client information.

Client receives the digital camera either by mail or directly through the kiosk or by distribution of a vendor coupon voucher. Client also receives specific instructions for obtaining images of the location client requires for design. Client places a ruler in the visual field of the image to establish a measuring standard or reference point. However, photogrammetric analysis obviates the requirement of a dimensional standard. The instructions indicate that digital images may be transmitted to the main computer either through a direct phone link, by physically sending the memory media storing the images, or via Internet transmission. Client opts to transmit the images via the Internet using his personal home computer.

Client is then contacted directly by the designer confirming receipt of the digital images and initiating the designer-client personal relationship. The designer then creates a plan conforming to client's general specifications and requirements and transmits the design in digital form to the main computer in a form that is securely accessible from client's specific account but not accessible from other client accounts. Client is informed that the design and account information is also available at the kiosk location upon entry of required account security information. Client reviews the design plan on his home computer and contacts the designer by telephone with several modifications. Client and designer simultaneously view the design plan and make revisions in real-time as the designer operates the design software in response to client's directions. Client reviews the design plan and makes cabinet style selections and orders the selections from a provided vendor on-line catalogue, using a secure account algorithm. Client visits a vendor location and views countertop styles in person and then logs onto his account using a kiosk located at the vendor location. Client makes places his order.

Client takes the before and after “after” pictures using the provided digital camera, transmits the digital images to the main computer via his home personal computer internet connection and stores the images in his account for future reference.

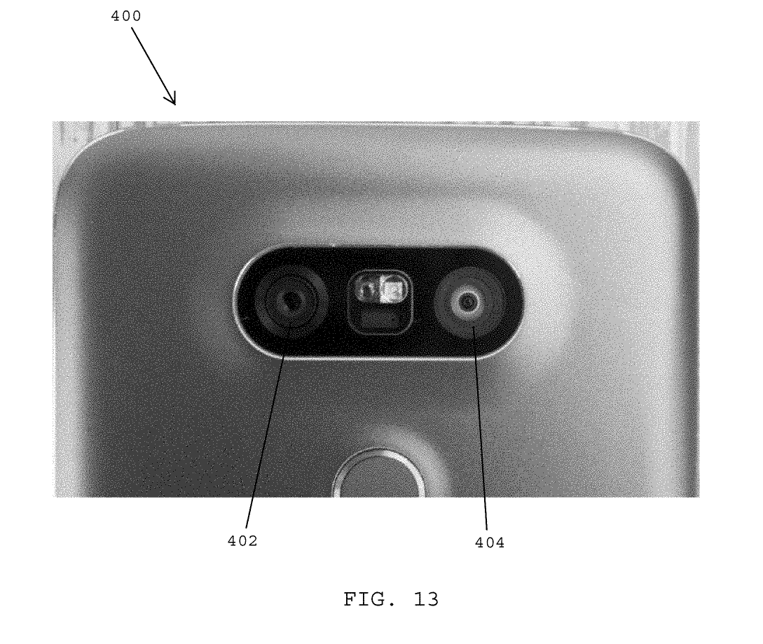

Referring to FIG. 13, in one embodiment, an electronic device 400, such as a smart phone, a tablet or an image capturing device, preferably has a first camera 402 and a second camera 404 that is spaced from the first camera. In one embodiment, the distance between the two cameras 402, 404 is known, which enables photogrammetry to be utilized to obtain information regarding the dimensions of a physical space. In one embodiment, the electronic device 400 may be utilized to simultaneously obtain two different photographs of a physical space using each of the first and second cameras 402, 404. For example, the electronic device 400 may be used to simultaneously obtain two photographs of a room, such as a kitchen or bathroom, which may be automatically processed using photogrammetry to derive dimension data for the room. As such, a user does not have to move, shift to the left or the right, or change the angle of photographing the physical space to collect data that may be photogrammetrically assimilated for producing three-dimensional data set renderings of the physical space.

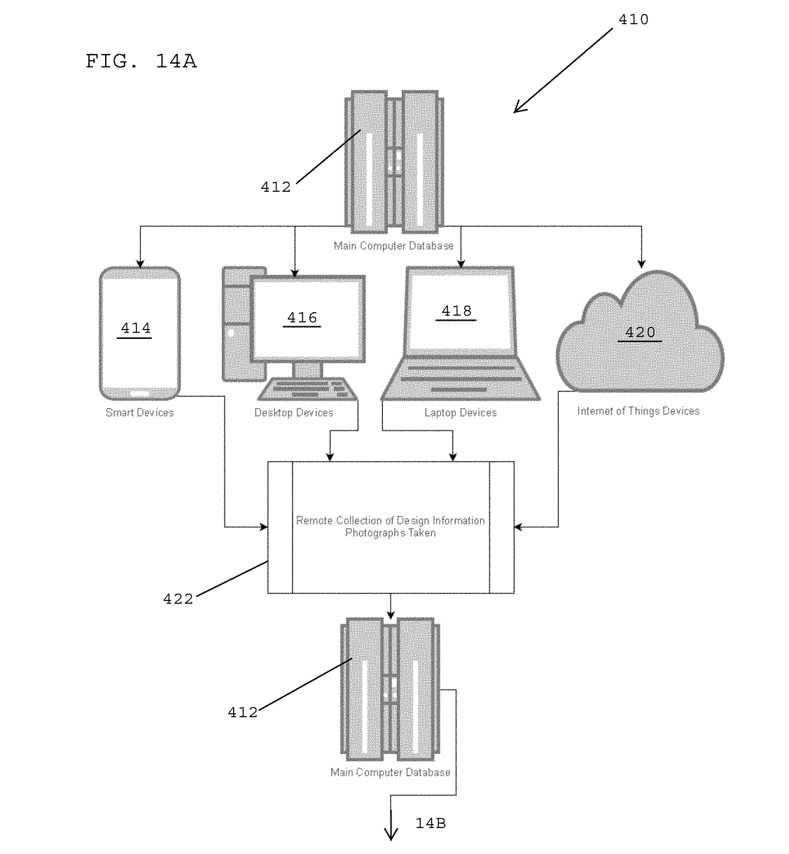

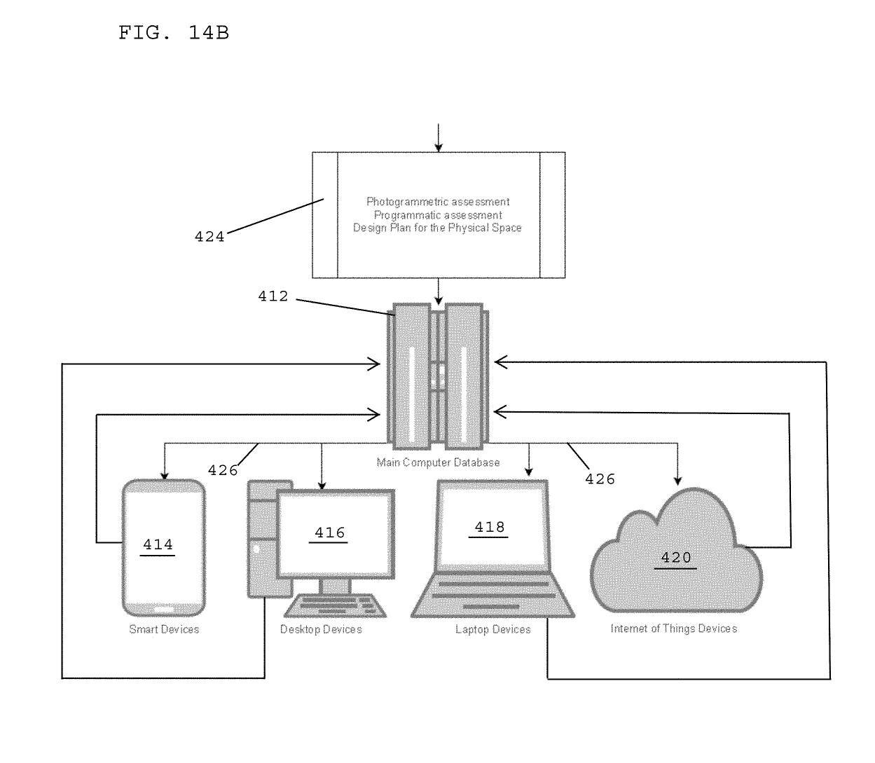

Referring to FIG. 14A, in one embodiment, a system for automatically generating a design plan for a physical space, such as a kitchen or bathroom, preferably includes a main computer 412 that contains a database of various design products for physical spaces (e.g., cabinetry, countertops, plumbing fixtures, windows, window coverings, etc.) The main computer database is preferably adapted to be in sending and receiving communication with a wide variety of electronic devices including smart devices 414, such as smart phones and tablets, desktop computer devices 416, laptop computer devices 418, and other internet-based devices 420 that are able to communicate via phone line, the internet, wirelessly, or via a Cloud-based environment. In one embodiment, the smart devices 414, the desktop computer devices 416, the laptop computer devices 418, and the internet-based devices 420 are in sending and receiving communication with the main computer 412 for providing information to the main computer and accessing information stored on the main computer database.

In one embodiment, the electronic device 400 having first and second cameras 402, 404 (FIG. 13) is utilized to take pictures or capture electronic images of a physical space. In one embodiment, the pictures or electronic images are initially captured without using a target or a ruler placed within the physical space (for obtaining dimension data). In one embodiment, two pictures or electronic images of the physical space are obtained simultaneously by the first camera 402 and the second camera 404. The known distance between the first and second cameras 402, 404 provides two pictures of the same physical space at slightly different angles relative to the electronic device. Although the present invention is not limited by any particular theory of operation, it is believed that simultaneously obtaining two pictures at the same time from two cameras having a known distance therebetween will enable photogrammetric techniques to be utilized for obtaining the dimensions of the objects captured in the two pictures. For example, the two pictures from two different angles may be used to determine the height of a wall or the height of a cabinet located within the physical space.

Referring to FIG. 14A, in one embodiment, at the stage designated 422, the pictures captured by the electronic smart device 414 having first and second cameras are collected and transmitted to the main computer 412. Additional sets of pictures may be taken and transmitted to the main computer 412.

Referring to FIG. 14B, in one embodiment, at stage 424, a photogrammetric assessment of the photographs or electronic images is made by the central processing unit of the main computer database 412 (FIG. 14A). The pictures or electronic images that are captured and communicated by the electronic device 400 (FIG. 13) are utilized by the system to develop dimension data for the physical space. The dimension data for a particular project may be stored in a memory device or a database of the main computer 412.

In one embodiment, the system assesses the photographs or electronic images that have been submitted by a customer to automatically evaluate whether the submitted images contain good data that may be used by the system for extracting accurate dimension data for a physical space, or bad data that should be ignored by the system because it cannot be used for extracting accurate dimension data for the physical space. In one embodiment, the photographs may be captured by electronic devices having one camera or two cameras as shown and described above for the embodiment of FIG. 13. In one embodiment, one or more of the following criteria may be used for evaluating whether a submitted photograph or electronic image contains good data or bad data: 1) whether the photograph is blurry; 2) whether the photograph is in focus; 3) whether the photograph is too bright; 4) whether the photograph too dark; 5) whether the photograph has a proper orientation; 6) whether the camera was properly oriented when the photograph was taken; 7) the camera set-up; 8) the camera zoom; 9) the aperture opening of the camera; 10) the F-stop of the camera; 11) the aspect ratio of the camera.

In one embodiment, the system automatically determines the type of camera that was utilized to capture the photographs that have been submitted. The camera type information is utilized to determine whether submitted photographs contain good data or bad data. In one embodiment, the system is able to identify the type of camera that has been used by obtaining the digital fingerprint for the submitted photographs and comparing the digital fingerprint to a database of digital fingerprints that may be used to identify unique types of cameras. In one embodiment, a user may provide information regarding the type of camera that was utilized to obtain photographs and/or electronic images. In one embodiment, depending upon the type of camera that has been used to obtain the photographs and/or digital images, the system may use different sets of criteria for evaluating whether a submitted photograph contains good data or bad data. In one embodiment, a system may deem a photograph to contain good data if most or a majority of the criteria are acceptable. In one embodiment, a system may reject a photograph as containing bad data if only one of the criterion is not satisfied. In one embodiment, the system maintains a database for each type of camera that may be used for submitting photographs and continuously updates the database and the criteria for evaluating photographs each time a project has been completed or on a periodic basis (e.g., daily, weekly, monthly). In one embodiment, the system is iterative and continuously updates and builds upon previous collected photographic and dimension data.

Every camera has a distinct lens profile such as a unique curvature of the lens and a unique focal point. In one embodiment, the system utilizes the information regarding the distinct lens profile of a camera when evaluating the submitted photographs to determine whether the photographs contain good data or bad data. The system continuously updates databases and memory files for each type of camera that is used to submit data to the system.

In one embodiment, a system may calculate dimension data for a physical space using as few as two photographs. In one embodiment, customers are encouraged to submit as many photographs as possible for use by the system for obtaining dimension data. In one embodiment, the system preferably provides real time feedback regarding whether a submitted photograph is usable (i.e., contains good data) or is unusable (i.e., contains bad data).

In one embodiment, the system is able to extract orientation data from a photograph for determining whether a photograph is usable or not usable. In one embodiment, the system obtains the orientation data from an electronic camera having an on-board gyroscope. In one embodiment, the system preferably provides real time feedback to a customer to advise the customer to adjust the aim of a camera up, down, left, right, closer to an object, and/or further away from an object. For example, the system may reject a first photograph in real time and advise a customer to move the aim of a camera up slightly before taking a second photograph. The system may then provide real time feedback regarding whether the second photograph is acceptable (i.e., contains good data) or unacceptable (i.e., contains bad data).

In one embodiment, the system preferably utilizes photogrammetry software and applications for obtaining the dimension data from uploaded photographs. In one embodiment, the photogrammetry software preferably extracts three-dimensional measurements and models from photographs taken with an ordinary camera or electronic device. The device used to capature photographs may have one camera, or two cameras that simultaneously capture two photographs. In one embodiment, the photogrammetry software may be sold under the trademark PHOTOMODELER by PhotoModeler Technologies of Vancouver, British Columbia, Canada. In one embodiment, the PHOTOMEDELLER software provides a cost-effective way for accurate three-dimensional scanning, measurement, surveying and reality capture.

The system disclosed herein provides numerous advantages over prior art systems including the fact that customers do not have to receive on-site visits from strangers when submitting dimension data for a project or commencing a project for renovating an interior space. The system preferably boosts engagement and promotion by customers who will tell their friends that they were able to commence and/or substantially complete the majority of a renovation project for a physical space without requiring an on-site visit for obtaining dimension data and prospecting.

In one embodiment, the system enables dimension and other data to be obtained for remote locations (e.g., areas having no internet access). When at a remote location lacking internet access, a user may take photographs of the remotely located physical space. When the user returns to a location having internet access, the user may upload the photographs to the system for evaluation.

In one embodiment, after the dimension data and/or photographs that have been submitted are deemed acceptable and/or useable, the system may send targets to a customer. The targets preferably placed within a physical space (e.g., taped to a wall or cabinet) and used by the customer for generating additional photographs that contain the targets. The targets may be sent to a customer electronically for being printed out by the customer at his or her location, or may be physically mailed to a customer.

In one embodiment, the system evaluates how serious a customer is using the time that elapses between photographs being uploaded by the customer. In one embodiment, if a customer uploads many photographs within a short period of time, the user may receive a higher ranking indicating that the customer is likely to complete a transaction and/or is highly motivated to complete a transaction. In one embodiment, if a long period of time elapses between a customer's submission of a first photograph and a second photograph, the user may receive a lower ranking indicating that the customer is less likely to complete a transaction and/or is less motivated to complete a transaction.

In one embodiment, the system collects, organizes and maintains the dimension data that has been obtained for each project to correct for any errors or discrepancies that result. For example, during installation, the dimensions found at a physical location may differ from the dimension data calculated by the system. In one embodiment, the dimension data for a project is preferably maintained in memory and/or in a database, and may be accessed during or after a project has been completed to analyze any inconsistencies that may result between the dimension data tabulated by the system and the dimension data found at an actual, physical location.

In one embodiment, the main computer database is able to use different types of information to evaluate and rank a customer/prospect. In one embodiment, the different data utilized by the main computer 412 includes dimension data directed to the physical dimensions obtained for a physical space, project data generally directed to the type of work that a customer has requested to be performed for renovating a physical space, and demographic data related to the economic and/or demographic profile of a customer/prospect. In one embodiment, the demographic data may be enhanced by utilizing third party databases that track home values, credit ratings, neighborhood quality of life, income levels, etc. of potential customers/prospects. Additional demographic data may include home values, income levels, the number of families living in an area, the number of single individuals living in an area, and/or the number of retired individuals living in a particular area. In one embodiment, the demographic data may be collected without the knowledge of a customer/user, or the customer may provide some of the demographic data.

In one embodiment, a user/customer will select and/or provide particular renovation parameters for a physical space. The main computer database preferably stores different types of design parameters having different cost levels. A user may also indicate the extent of renovations to be done within the physical space. For example, a user may select lower cost cabinetry or more expensive cabinetry having finer finishes. The information entered by a user regarding the extent and cost of the renovation is collected by the main computer database and catalogued as project data. Project data may include any design or style preferences selected or chosen by the customer. In one embodiment, the main computer database may include a rating system that utilizes the dimension data for a physical space that has been obtained using the electronic device having two cameras; the project data entered by the user regarding the scope and/or cost of a possible renovation; and the demographic data related to the home value, income level, number of families in an area, etc. to automatically generate a rating for a potential customer. For example, if the budget proposed by a potential customer greatly exceeds his or her ability to pay as determined by the demographic data, then the main computer database will provide a lower ranking for the customer because the likelihood that the customer can afford to pay for the contemplated project is low. In addition, if a customer has a large physical space, but the selected budget is insufficient for completing an appropriate renovation project for the physical space, the main computer database will provide a lower ranking for the user.

In one embodiment, a rating system, individual examples of which may be generated procedurally based on a combination of user input, demographic data, and/or known business principles, may comprise a self-directing iterative refinement process. In one embodiment, the rating system may be driven by a machine learning algorithm that preferably analyzes new project data based on past performance metrics (sales performance, etc.) to gauge, estimate, evaluate and/or re-evaluate a current prospect in real time. In one embodiment, the data assessed by the algorithm may be supplemented by data input by a human, such as data having a subjective nature. In one embodiment, the data may include data collected through surveys, both web and phone based. The data may, in turn, be subject to the same algorithmic machine learning to refine its performance and relevance.

In one embodiment, a rating system may include a periodically directed iterative refinement process. The rating system may form a series of paradigms by which the system operates, each more refined than the last, separated through time in regular intervals (i.e. monthly, quarterly, semi-annually). The rating system may be updated on a periodic basis, with the data collected in the interim between the present and the previous iteration of the rating system being used to further refine the system based on past performance metrics to create a new iteration, which may then be used to gauge, estimate, evaluate and/or re-evaluate new prospects until the next iteration is calculated.

In one embodiment, if a user has been evaluated to be a legitimate prospect (e.g., using demographic data), the system may automatically send one or more targets or rulers to the user for placement within the physical space for obtaining enhanced dimension data for the physical space. Thus, in one embodiment, initial prospecting and ranking of a user does not require the user to have a target or ruler placed within the physical space when taking pictures. Only after the user has been initially screened and verified as being a legitimate customer (suing the dimension data, the project data and the demographic date) does the system automatically generate and transmit a target or ruler to the user for placement in the physical space for obtaining enhanced dimension data of the physical space.

In one embodiment, if the user's budget (as expressed by the user) is too low for the project data that has been selected, the main computer database may automatically recommend a change to the project so that the scope of the project is more in line with the budget, whereby a suitable project may be completed within a budget that is acceptable to the user. In one embodiment, if the data indicates that the user is a prospect for an upgraded project, the main computer database may automatically recommend an upgraded project (e.g., higher quality cabinetry, better fixtures) for enhancing the quality of the renovation project.

Referring to FIG. 14B, in one embodiment, at stage 426, after the main computer 412 has received, obtained and/or processed the dimension data, the project data, and the demographic data, the project information may be transmitted to various electronic devices such as the smart devices 414, the desktop devices 416, the laptop devices 418 and the internet devices 420. In one embodiment, any information related to a project is iterative in nature with information and changes being constantly made and/or transmitted back and forth between the electronic devices 414, 416, 418 and 420 and the main computer.

In one embodiment, an electronic device, such as a smart phone or tablet, having two cameras may be utilized for obtaining pictures and/or electronic images of a physical space, whereby the two cameras simultaneously obtain the pictures/electronic images at different angles. In one embodiment, the electronic device having the two cameras preferably utilizes augmented reality (AR) which enables accurate dimension information for the physical space to be obtained. In one embodiment, the two cameras are spaced away from one another by a known distance so that two pictures may be simultaneously taken of the same physical space with the different angles of the pictures being utilized in association with photogrammetric technology for obtaining dimension data for the physical space. Thus, during initial screening of a customer, a target or ruler does not have to be in the possession of the user/customer for being positioned within a physical space in order to take advantage of photogrammetric technology.

As used herein, the terminology augmented reality (AR) may mean a live direct or indirect view of a physical, real-world environment whose elements are “augmented” by computer-generated or extracted real-world sensory input such as sound, video, graphics or GPS data. AR is related to a more general concept called computer-mediated reality, in which a view of reality is modified by a computer. Augmented reality enhances one's current perception of reality, whereas in contrast, virtual reality replaces the real world with a simulated one. In one embodiment, Augmentation techniques may be performed in real time and in semantic context with environmental elements, such as overlaying supplemental information like scores over a live video feed of a sporting event. See https://en.wikipedia.org/wiki/Augmented_reality.

With the help of advanced AR technology (e.g. adding computer vision and object recognition) the information about the surrounding real world of the user becomes interactive and capable of digital manipulation. In one embodiment, information about the environment and its objects is overlaid on the real world. The information may be virtual or real, e.g. seeing other real sensed or measured information such as electromagnetic radio waves overlaid in exact alignment with where they actually are in space. Augmented reality brings out the components of the digital world into a person's perceived real world. One example is an AR Helmet for construction workers which display information about the construction sites. The first functional AR systems that provided immersive mixed reality experiences for users were invented in the early 1990s, starting with the Virtual Fixtures system developed at the U.S. Air Force's Armstrong Labs in 1992. Augmented Reality is also transforming the world of education, where content may be accessed by scanning or viewing an image with a mobile device. See https://en.wikipedia.org/wiki/Augmented_reality.

In one embodiment, Augmented Reality (AR) technology may be used for compiling and/or collecting demographic information that is used for ranking customers. In one embodiment, AR is able to indentify via the Global Positioning Satellite (GPS) system the physical location and/or the address of a customer for deriving demographic data associated with a customer. In one embodiment, AR may be used for analyzing a customer's Internet Protocol (IP) Address for developing demographic data associated with the customer.

In one embodiment, the initial dimension data, project data, and demographic data are all used by the system to evaluate and rank order customers. If the system determines that a customer is qualified, the system will automatically generate a signal that results in a target or ruler to be sent to the user for obtaining additional pictures. As such, initial evaluation of a customer may take place without sending a target or ruler to the customer. After a customer has been qualified, the customer may be directed to place the target or ruler within a physical space and obtain additional photographs with the target in the pictures thereby providing verified dimension data for the physical space.

In one embodiment, the system is designed to remove (or provide a low ranking to) customers who are not serious about completing a project, have expressed interest in pursuing an unrealistic project (e.g., the size of the physical space is too large for the size of the budget) and/or are economically disqualified from completing a project. The system preferably uses the photogrammetric data obtained by taking the pictures, the project information entered by the user regarding the type and scope of renovation that is desired, and demographic data about the user. The system preferably enters the dimension data, the project data, and the demographic data into the main computer database and the main computer database evaluates the information and automatically rates a customer to indicate whether the customer is a good candidate (i.e., likely to buy and complete a project), a bad candidate (i.e., unlikely to complete or be able to pay for a project), a neutral candidate (i.e., possibly able to complete and pay for a project), and at a range of different positions along the scale from good candidate to bad candidate. The rating system is generated automatically by the main computer database.

In one embodiment, if the system determines that a customer does not have the economic means to fund a project at an expressed budget, the customer will receive a lower rating. In one embodiment, if the customer indicates that the desired time for completing a project is long into the future, the system may automatically generate a low rating for the customer. In one embodiment, if a customer initially selects a lower quality project with lower value components, and the system recognizes the individual as having a high income level, the system may automatically make recommendations to the customer to upgrade the renovation project.

In one embodiment, the system utilizes the dimension data, the project data, and the demographic data to generate a rating to categorize a customer. The system preferably uses historical data for a large number of customers (i.e., from a pre-existing database) to complete the evaluation process. In one embodiment, customers may receive different color ratings including a red rating for a no go or low rank customer, a yellow rating for an intermediate quality customer, and a green rating for a customer that is highly likely to successfully complete and pay for the selected renovation project (i.e., a customer's engagement level). In one embodiment, customers may be assigned a numeric rating, such as from 1-10 or 1-5, which relates to the scale of a project. For example, a low dollar project may receive a numeric rating of one, and a high dollar project may receive a numeric rating of ten. In one embodiment, the system may utilize a combination of both a color rating that relates to a customer's engagement level and a numeric rating that relates to the scale (i.e., size) of a project.

In one embodiment, the system may use a central processing unit for automatically comparing the dimension data that has been collected (e.g., by taking photographs of a physical space) with budget data provided by the user to determine if the budget makes sense for the dimensions of the physical space (based upon historical data). If the size of a physical space does not match the size of the budget (using historical data), the system may automatically make a recommendation to upgrade or downgrade the budget or the scope of the renovation project and/or rate a customer with a higher or lower rating.

In one embodiment, the system may utilize the address of any individual for generating demographic data.

In one embodiment, the system interprets the dimension data entered by a user as another piece of data when evaluating and rating a customer. The dimension data is used by the system as a prospecting tool for automatically evaluating customers.

In one embodiment, the system disclosed herein is utilized for renovating interior spaces such as kitchens, bathrooms, other rooms of a house, condominiums, and/or apartments. In one embodiment, the system may be utilized for purchasing new windows or renovating windows. The system may also be utilized for purchasing window coverings or obtaining quotes for paint jobs for painting interior walls of a room. In other embodiments, the system may be utilized for fish tank design projects, patio design projects or pool design projects. The system may also be utilized for replacing countertops in kitchens and bathrooms.

In one embodiment, the initial prospecting and evaluation of a customer may be done automatically by a main computer database. In one embodiment, a customer uploads dimension data obtained by taking photographs of a physical space. The customer also uploads information related to project data such as a budget size or the type of cabinetry desired for renovating a physical space. The system preferably utilizes the dimension data and the project data in conjunction with the demographic data available for a customer to rank the customer on criteria such as the likelihood of project completion for the size of the physical space, and to rank a customer at various levels based upon ability to complete and pay for a renovation project.

In one embodiment, if the system determines that a customer has obtained a particular rating, the system will automatically proceed with a next phase of a project, which includes sending a target or ruler to a user for placement within a physical space. Once the target or rule is received by the customer, the target or ruler is preferably secured within the physical space (e.g., taped to a wall) and additional photographs of the physical space are obtained (with the target or ruler in the new pictures) to obtain more exacting dimension data.

In one embodiment, the system utilizes the dimension data, the project data, and the demographic data to create a tiered hierarchy of customers. Higher ranked customers may receive more attention from sales and design personnel than lower ranked customers. In one embodiment, the system may automatically forward the contact information for higher ranked customers to more experienced and/or better salespersons, while lower ranked salespersons may be tasked with handling lower ranked customers.

In one embodiment, after a customer has been fully vetted, ranked and contacted by a salesperson, a design professional may assist the customer in designing a renovation project for the physical space, such as selecting cabinetry, fittings, countertops, etc. In one embodiment, a customer is assigned a salesperson only after the system confirms that the dimension data that has been submitted for a physical space is useable and accurate. In one embodiment, a customer is assigned to a design professional only after the customer has completed certain tasks with a salesperson and has been fully vetted as being a legitimate customer who is likely to complete a renovation project.

In one embodiment, the system may include a software application used by design professionals such as the design application sold under the trademark 2020 by Technologies 20-20 Inc., located in Laval, Quebec, Canada.

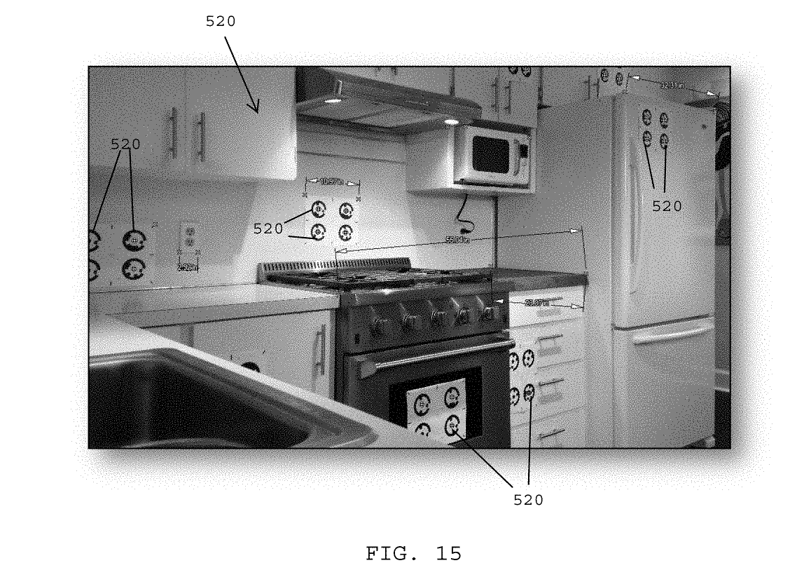

Referring to FIG. 15, in one embodiment, digital images (e.g., electronic photographs) of a physical space 520 may be captured. In one embodiment, targets 522 are preferably secured to surfaces located within the physical space 520. In one embodiment, two or more digital images of the physical space 520 are captured, with the targets 522 preferably being visible within the digital images. The digital images may be captured using an electronic device, such as a smart phone having a camera. The digital images are preferably transmitted to a main computer system that uses photogrammetry software for generating dimension data associated with the physical space. The main computer system may use quality control criteria for evaluating whether the transmitted digital images are satisfactory for extracting dimension data (e.g., in good focus) or are unsatisfactory for extracting dimension data (e.g., out of focus; too dark). The computer system will preferably use the digital images that satisfy the quality control criteria and reject the digital images that do not satisfy the quality control criteria. The main computer system may send one or more messages to a customer that transmitted digital images are satisfactory or unsatisfactory and may prompt the customer in real time to capture additional digital images for supplying a sufficient number of digital images that satisfy the quality control criteria. In one embodiment, the dimension data generated from the transmitted photographs that satisfy the quality control criteria may be used for rating a customer and designing products (e.g., kitchen cabinets) that will be placed into the physical space.

Throughout this application, various publications and patents and patent applications are referenced. The disclosures of these publications in their entireties are hereby incorporated by reference into this application in order to more fully describe the state of the art.

This invention may be embodied in other forms or carried out in other ways without departing from the spirit or essential characteristics thereof. The present disclosure is therefore to be considered as in all respects illustrative and not restrictive, the scope of the invention being indicated by the appended claims, and all changes which come within the meaning and range of equivalency are intended to be embraced therein.

What is claimed is:

1. A computer-implemented method of rating customers for design projects comprising:
providing a main computer system comprising a database of design products;
transmitting two or more digital images of a physical space to said main computer system;
using said main computer system for identifying any of the transmitted digital images that satisfy predetermined quality control criteria;
using photogrammetry software for processing the transmitted digital images that satisfy the predetermined quality control criteria to generate dimension data for the physical space.

2. The method as claimed in claim 1, further comprising using the dimension data for generating a three-dimensional data set rendering of the physical space.

3. The method as claimed in claim 1, wherein the transmitting two or more digital images of the physical space comprises using an electronic device for capturing the two or more digital images of the physical space and using the internet for electronically transmitting the two or more captured digital images to said main computer system.

4. The method as claimed in claim 3, wherein said electronic device comprises a camera.

5. The method as claimed in claim 4, further comprising:
placing at least one object within the physical space;
directing the camera toward the physical space;
using the camera to capture a first digital image of the physical space, wherein said at least one object is visible within the first digital image;
changing the angle at which the camera is directed toward the physical space and using the camera to capture a second digital image of the physical space, wherein said at least one object is visible within the second digital image, and wherein said at least one object is visible within the captured first and second digital images.

6. The method as claimed in claim 4, wherein said electronic device comprises a second camera that is offset from said first camera, and wherein said first and second cameras are configured to simultaneously capture two different digital images of the physical space.

7. The method as claimed in claim 1, further comprising:
using Global Positioning System (GPS) technology for determining a geolocation that is associated with the transmitted digital images;
using the geolocation that is associated with the transmitted digital images for generating demographic data about a customer.

8. The method as claimed in claim 7, further comprising using the dimension data for the physical space and the demographic data about the customer to assign a rating to the customer.

9. The method as claimed in claim 8, further comprising:
using the rating assigned to the customer to determine if the customer is a qualified lead;
if the customer is a qualified lead, sending two or more targets to the customer for use in capturing supplemental digital images of the physical space.

10. The method as claimed in claim 9, further comprising:
obtaining a selection from the customer regarding one or more design products in said database of design products to generate project data linked to the customer;
using the project data linked to the customer for generating the rating assigned to the customer.

11. The method as claimed in claim 10, further comprising using an internet protocol (IP) address associated with the customer for generating additional demographic data about the customer.

12. The method as claimed in claim 1, wherein said main computer is configured to send and receive communications from electronic devices for transmitting said two or more digital images, wherein said electronic devices are selected from the group consisting of smart devices, smart phones, tablets, electronic cameras, desktop computers, laptop computers, and internet-based devices capable of communicating via phone lines, the internet, wirelessly, and via a Cloud-based environment.

13. The method as claimed in claim 10, further comprising:
using the dimension data, the demographic data, and the project data linked to the customer to create a rating for the customer;
comparing the rating for the customer to ratings assigned to other customers to create a tiered rating hierarchy.

14. The method as claimed in claim 1, wherein the quality control criteria are selected from the group consisting of the blurriness level of a digital image, the focus level of a digital image, the brightness level of a digital image, the darkness level of a digital image, the orientation of a digital image, the orientation of a camera that captured a digital image, a camera set-up, a camera zoom, a camera aperture opening, the F-stop of a camera, a digital fingerprint of a camera, and the aspect ratio of a camera.

15. The method as claimed in claim 1, further comprising:
rejecting any of the transmitted digital images that do not satisfy one or more of the quality control criteria;
generating a message to a customer that one or more of the transmitted digital images has been rejected for not satisfying one or more of the quality control criteria.

16. A computer-implemented method of rating customers for design projects comprising:
providing a main computer system comprising a database of design products;
capturing two or more digital images of a physical space;
transmitting the two or more digital images of the physical space to said main computer system;
identifying any of the transmitted digital images that satisfy predetermined quality control criteria;
using photogrammetry software for processing the transmitted digital images that satisfy the predetermined quality control criteria to generate dimension data for the physical space;
extracting geolocation information from the transmitted digital images of the physical space;
using the extracted geolocation information to generate demographic data for a customer;
obtaining from the customer a selection of at least one design product from the database of design products to generate project data linked to the customer;
using the dimension data for the physical space, the demographic data for the customer, and the project data linked to the customer to create a rating for the customer.

17. The method as claimed in claim 16, further comprising:
using the rating assigned to the customer to determine whether the customer is a qualified lead;
if the customer is a qualified lead, sending targets to the customer for use in capturing supplemental digital images of the physical space.

18. The method as claimed in claim 17, further comprising:
placing the targets in the physical space;
capturing two or more supplemental digital images of the physical space, wherein the two or more targets are visible within the two or more supplemental digital images;
transmitting the two or more supplemental digital images to said main computer;
using said photogrammetry software for processing the transmitted two or more supplemental digital images to generate supplemental dimension data for the physical space;
comparing the first dimension data for the physical space with the supplemental dimension data for the physical space.

19. A computer-implemented system for rating customers for design projects comprising:
a main computer system comprising photogrammetry software and a database of design products;
code for capturing two or more digital images of a physical space;
code for transmitting the two or more captured digital images of the physical space to said main computer system;
code for identifying any of the transmitted digital images that satisfy predetermined quality control criteria;
code for using photogrammetry software for processing the transmitted digital images that satisfy the predetermined quality control criteria to generate dimension data for the physical space;
code for extracting geolocation information from the transmitted digital images of the physical space;
code for using the geolocation information extracted from the transmitted digital images to generate demographic data for a customer;
code for obtaining from the customer a selection of at least one design product from the database of design products to generate project data linked to the customer;
code for using the dimension data for the physical space, the demographic data for the customer, and the project data linked to the customer to create a rating for the customer.

20. The system as claimed in claim 19, further comprising:
code for using the rating assigned to the customer to determine whether the customer is a qualified lead;
code for sending targets to customers who have been determined to be qualified leads;
code for capturing two or more supplemental digital images of the physical space, wherein the targets are visible within the two or more supplemental digital images;
code for transmitting the two or more supplemental digital images to said main computer;
code for using said photogrammetry software for processing the transmitted two or more supplemental digital images to generate supplemental dimension data for the physical space;
code for comparing the first dimension data for the physical space with the supplemental dimension data for the physical space.
